(19) United States
(12) Patent Application Publication
(10) Pub. No.: US 2010/0049408 A1
(43) Pub. Date: Feb. 25, 2010

(54) CONTROL DEVICE FOR IMPROVING THE TRACTION OF A VEHICLE

(75) Inventors: Vincent Abadie, Sartrouville (FR); Philippe Blaise, Dampierre les Bois (FR); Damien Joucgnoux, Fontenay sous Bois (FR)

Correspondence Address: NICOLAS E. SECKEL;Patent Attorney, 1250 Connecticut Avenue, NW Suite 700, WASHINGTON, DC, 20036, US

(73) Assignees: PEUGEOT CITROEN AUTOMOBILES S.A., Velizy Villacoublay (FR); ROBERT BOSCH GMBH, Stuttgart (DE)

(21) Appl. No.: 12/516,548

(22) PCT Filed: Nov. 21, 2007
(86) PCT No.: PCT/EP2007/062663

§ 371 Date: Jul. 7, 2009

(30) Foreign Application Priority Data
Nov. 27, 2006 (FR) 0655120

(51) Int. Cl. G06F 19/00

(52) U.S. Cl. 701/48

(57) ABSTRACT

The invention relates to a vehicle control device comprising: —means (10, 20, 30) for generating various control modes dependent on parameters concerned with the way in which the vehicle is moving such as, rotational speed of the wheels, yaw rate, lateral acceleration and longitudinal acceleration, pressure on the brake controls exerted by the driver, and a vehicle life situation mode chosen by the driver from various preestablished life situations corresponding to different types of road and terrain and different vehicle rolling conditions, —estimating means (40) for estimating the vehicle life situation, the device being configured to determine an optimum control mode (32, 34, 36, 38) from among the various control modes that can be generated by the device as a function of the estimated vehicle life situation and the life situation mode chosen by the driver.

The present invention concerns devices for improving the traction of motor vehicles rolling on roads or terrains having different characteristics and according to different life situations.

It more particularly, but not exclusively, concerns a device for controlling a vehicle with two drive wheels (4×2).

The concerned life situations are forward gear and reverse driving on roads or terrains having:
muddy portions, grass, ruts, mires (all-terrain driving),
sand,
snow or ice,

and for a variety of slopes.

In these life situations, the systems used in the vehicle are
either 4×4 transmission (four drive wheels)
or specific devices on 4×2 vehicles (two drive wheels): standard antiskid or limited slip differentials.

Anti-skid devices, also designated by the acronym ASR (Anti Slip Regulation), are intended to improve the rolling traction of a motor vehicle on all types of terrain.

These devices are potentially applicable to any two drive wheel 4×2 or four drive wheel 4×4 vehicle equipped with a dynamic path control system, also called ESP (Electronic Stability Program), and make it possible change the traction performance of the vehicles significantly.

ESP serves various functions such as:
control of CDC yaws;
anti-lock braking system (ABS),
antiskid (ASR);
and other safety functions for driving the vehicle.

The limitations of these devices are explained below:

Concerning 4×2 vehicles:
the Limited Slip Differential: this system, through its operating mode, generates, under certain conditions, blocking of the differential, which equalizes the rotational speeds of the wheels. Thus, on moderate left/right grip differences (for example, wet grass on one side, dirt on the other), traction will be slightly improved. However, performance is limited in particular under conditions of more significant left/right grip differences or low homogenous grip.
traditional ASR: since its appearance on vehicles, ASR has been perfected, which has allowed a continuous improvement of its general performance. The ASR system, through limitation of engine torque (AMR) and brake pressure apportioning (BASR), limits slipping of the wheels. The current performance of traditional ASRs remains, however, very limited in all-terrain driving situations, due to the need to manage many compromises in the development of the system, in particular compatibility with driving between ice/snow and mud, for example.

Concerning 4×4 vehicles:
there are many types of 4×4 vehicles with more or less evolved AV/AR transmissions. The system's performance in terms of traction is significantly better than the solutions presented above. The main drawbacks of these solutions are: the very significant additional cost, the significant additional mass for the vehicle, their complexity in terms of development and improvement, and the geometric difficulty of integrating them into small and mid-size vehicles.

In order to offset the drawbacks of the devices for improving vehicle traction of the prior art, the invention proposes:

a vehicle control device, in particular for a vehicle with two drive wheels, moving on a road or terrain, intended to define engine torque and wheel braking instructions for the vehicle,

characterized in that it comprises:
means for generating different control modes depending on the way in which the vehicle is moving, such as rotational speed of the wheels, yaw rate, lateral acceleration and longitudinal acceleration, pressure on the brake controls exerted by the driver, and a vehicle life situation mode chosen by the driver from various pre-established life situations corresponding to different types of road and terrain and different vehicle rolling conditions,
estimating means for estimating the vehicle life situation, the device being configured to determine an optimum control mode from among the various control modes that can be generated by the device as a function of the estimated vehicle life situation and the life situation mode chosen by the driver.

Advantageously, the means for estimating the life situation of the vehicle comprises a logic for recognizing the type of roads or terrains confirming or not confirming the life situation mode chosen by the driver.

In one embodiment of the device according to the invention, the control modes of the system consist of optimizing the working point of the tire in the longitudinal stress/slip rate reference, primarily as a function of:
the available grip, this estimate being done using sensors for the parameters concerned with the way in which the vehicle is moving and the mode selected by the driver,
the speed and longitudinal acceleration of the vehicle,
on bends, the yaw rate and the lateral acceleration of the vehicle.

In another embodiment, the means for generating the different control modes comprise:
a selection device (designator or selector) allowing the driver to select a life situation of the vehicle, for example all-terrain, snow, sand or other;
a status machine using the life situation information (all-terrain, snow, sand or other) coming from the selection device and information resulting from sensors present on the vehicle, in particular sensors for: rotational speed of the wheels, yaw rate, lateral acceleration and longitudinal acceleration, master brake cylinder control pressure to activate algorithms, some of which are specific,
control modules each comprising an algorithm corresponding to control strategies associated with different statuses in the status machine and which define engine torque and wheel braking control instructions.

In another embodiment, the control modules comprise a first module defining a control strategy for normal terrain or road, a second module defining a strategy for muddy roads, a third module for sandy roads and a fourth module for snowy roads.

In another embodiment, the status machine as well as the control modules are implanted in a logic controller of the vehicle, for example in the vehicle's ESP.

In another embodiment, the selection device is arranged on the dashboard in the form of a vehicle life status mode selector button accessible by the driver.

The system consists of a device for controlling the engine torques and four wheel braking differentiated according to the life situations. This control may be done by an ESP-type braking system which makes it possible to obtain independent braking pressures on all four wheels and by the engine, which makes it possible to generate a positive torque to the wheels.

Differentiation as a function of the life situations is made possible manually by the presence of a designator on the dashboard (comprising, for example, normal/all terrain/snow/sand positions) which makes it possible to adapt the algorithms to the life situation which is perceived by the driver.

The invention will be better understood through the description of one embodiment of a control device according to the invention with the help of indexed drawings in which:

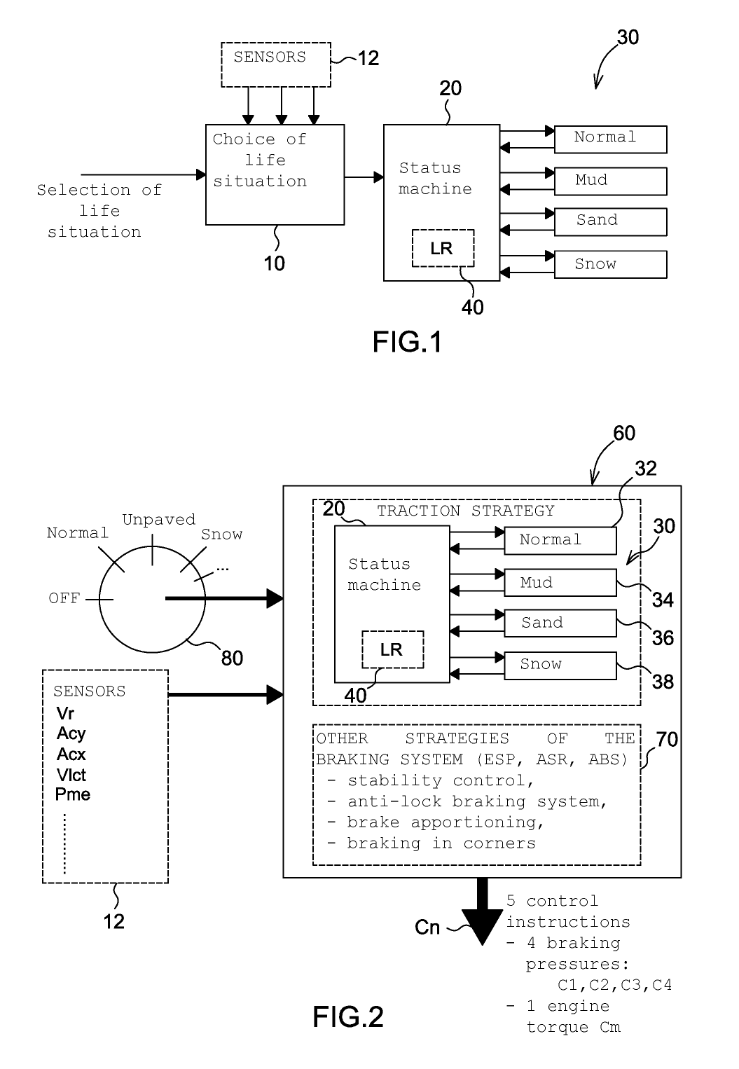

FIG. 1 is a schematic synopsis of the control device according to the invention; and

FIG. 2 shows an embodiment of the device of FIG. 1 according to the invention.

FIG. 1 illustrates a schematic synopsis of the control device according to the invention. The device comprises:
a selection device 10 (designator or selector) allowing the driver to select a life situation of the vehicle, for example all terrain, snow, sand or other;
a status machine 20 using the life situation information (all terrain, snow, sand or other) coming from the selection device and information coming from sensors 12 present on the vehicle, in particular rotational speed Vr of the wheels, yaw rate Vlc, lateral acceleration Acy and longitudinal acceleration Acx, master cylinder pressure Pm in order to activate algorithms, some of which are specific
control modules 30 each comprising an algorithm corresponding to control strategies associated with the different statuses of the status machine and which define engine torque and wheel braking instructions. For example, a first module 32 defining a control strategy on normal terrain or road, a second module 34 defining a strategy for muddy roads, a third module 36 for sandy roads and a fourth module 38 for snowy roads.

Description of the status machine 20 and control strategies for the modules 30:

The purpose of the status machine 20 is to activate control strategies. To this end, the status machine 20 integrates a recognition logic LR 40 for the type of terrain which makes it possible to confirm or not confirm the selection by the driver of the type of life situation, for example an estimate of the tire grip.

The device is configured to activate the optimum specific control strategies (modules 30) as a function of the life situation resulting from the grip estimate done by the device and indications from the driver (mode selected).

The control strategies of the device consist of optimizing the working point of the tire of each wheel of the vehicle in the longitudinal stress/slip rate reference.

Optimization of the working point is done primarily from values provided by the sensors or calculated from values provided by the sensors of the vehicle, in particular:
the available tire grip: an estimate of available grip is done using sensors 12 of the vehicle and the mode selected by the driver,
the speed and longitudinal acceleration of the vehicle: provided by the sensors,
on bends: the yaw rate and lateral acceleration of the vehicle provided by the sensors.

Certain functionalities of the control device according to the invention can be described as follows:
the selection device 10 (selector) comprises several positions corresponding to coating states or rolling conditions (number greater than or equal to 2),
the positions of the selection device 10 will be modifiable by the driver of the vehicle,
taking into account of requests by the driver on the selector may be inhibited by the device in certain life situations,
these positions may also be modified electronically by the device itself in certain life situations.

FIG. 2 shows an embodiment of the device of FIG. 1 according to the invention.

The status machine 20 as well as the control modules 30 are, for example, implanted in a logic controller 60 of the vehicle, for example in the ESP of the vehicle comprising in particular other modules 70 defining other types of strategies, for example strategies of the braking system (ESP, ASR, ABS) for:
stability control,
anti-lock braking system,
brake apportioning,
braking in corners or other.

A designator 80 (for example a vehicle life mode choice button) is arranged on the dashboard of the vehicle. The designator 80 is connected to the logic controller 60 in order to provide information to the status machine 20 on the choice by the driver of the life situation of the vehicle.

The sensors 12 connected to the logic controller 60 provide the status machine 20 with parameters on the way in which the vehicle is moving such as:
rotational speed of the wheels Vr,
lateral acceleration Acy,
longitudinal acceleration Acx,
yaw rate Vlct,
master cylinder pressure Pme.

The logic controller 60 provides five control instructions Cn for braking torque and engines of the wheels: four instructions C1, C2, C3 and C4 for braking pressure and one engine torque Cm instruction.

The control device according to the invention is potentially applicable to any 4×2 vehicle equipped with an ESP system and makes it possible to significantly change the traction performance of 4×2 vehicles. The system can also be generalized for 4×4 vehicles.

1. A vehicle control device, in particular for a motor vehicle with two drive wheels, rolling on roads or terrains, intended to define engine torque and wheel braking instructions for the vehicle, comprising:
means for generating different control modes as a function of parameters concerning the way in which the vehicle is moving, such as rotational speed of the wheels, yaw rate, lateral acceleration and longitudinal acceleration, pressure on the brake controls exerted by the driver, and a vehicle life situation mode chosen by the driver from various pre-established life situations corresponding to different types of roads and terrains and different vehicle rolling conditions,
estimating means for estimating the vehicle life situation, the device being configured to determine an optimum control mode from among the various control modes that can be generated by the device as a function of the estimated vehicle life situation and the life situation mode chosen by the driver, characterized in that the means for estimating the vehicle life situation comprise a recognition logic of the type of roads or terrains confirming or not confirming the life situation mode chosen by the driver.

2. The control device according to claim 1, wherein the control modes of the system consist of optimizing the working point of the tire in the longitudinal stress/slip rate reference, primarily as a function of:
the available grip, this estimate being done using sensors for the parameters concerning the way in which the vehicle is moving and the mode selected by the driver,
the speed and longitudinal acceleration of the vehicle,
on bends, the yaw rate and lateral acceleration of the vehicle.

3. The control device according to claim 1, wherein the means for generating different control modes comprise:
a selection device allowing the driver to select a vehicle life situation,
a status machine using the life situation information coming from the selection device and information coming from sensors present on the vehicle, in particular sensors for rotational speed of the wheels, yaw rate, lateral sand longitudinal acceleration, master cylinder pressure in order to activate algorithms, some of which are specific,
control modules each comprising an algorithm corresponding to control strategies associated with different statuses in the status machine and which define control instructions for engine torque and wheel braking.

4. The control device according to claim 3, wherein the control modules comprise a first module defining a control strategy for normal terrain or road, a second module defining a strategy for muddy roads, a third module for sandy roads and a fourth module for snowy roads.

5. The control device according to claim 3, wherein the status machine as well as the control modules are implanted in a logic controller of the vehicle.

6. The control device according to claim 5, wherein the status machine as well as the control modules are implanted in the ESP.

7. The control device according to claim 3, wherein the selection device is arranged on the dashboard of the vehicle, in the form of a choice button for the vehicle life mode, accessible by the driver.

8. The control device according to claim 4, wherein the status machine as well as the control modules are implanted in a logic controller of the vehicle.

9. The control device according to claim 8, wherein the status machine as well as the control modules are implanted in the ESP.

10. The control device according to claim 4, wherein the selection device is arranged on the dashboard of the vehicle, in the form of a choice button for the vehicle life mode, accessible by the driver.

11. The control device according to claim 5, wherein the selection device is arranged on the dashboard of the vehicle, in the form of a choice button for the vehicle life mode, accessible by the driver.

12. The control device according to claim 6, wherein the selection device is arranged on the dashboard of the vehicle, in the form of a choice button for the vehicle life mode, accessible by the driver.

13. The control device according to claim 2, wherein the means for generating different control modes comprise:
a selection device allowing the driver to select a vehicle life situation,
a status machine using the life situation information coming from the selection device and information coming from sensors present on the vehicle, in particular sensors for rotational speed of the wheels, yaw rate, lateral sand longitudinal acceleration, master cylinder pressure in order to activate algorithms, some of which are specific,
control modules each comprising an algorithm corresponding to control strategies associated with different statuses in the status machine and which define control instructions for engine torque and wheel braking.

14. The control device according to claim 13, wherein the control modules comprise a first module defining a control strategy for normal terrain or road, a second module defining a strategy for muddy roads, a third module for sandy roads and a fourth module for snowy roads.

15. The control device according to claim 13, wherein the status machine as well as the control modules are implanted in a logic controller of the vehicle.

16. The control device according to claim 15, the status machine as well as the control modules are implanted in the ESP.

17. The control device according to claim 13, wherein the selection device is arranged on the dashboard of the vehicle, in the form of a choice button for the vehicle life mode, accessible by the driver.

18. The control device according to claim 14, wherein the status machine as well as the control modules are implanted in a logic controller of the vehicle.

19. The control device according to claim 18, wherein the status machine as well as the control modules are implanted in the ESP.

20. The control device according to claim 14, wherein the selection device is arranged on the dashboard of the vehicle, in the form of a choice button for the vehicle life mode, accessible by the driver.
